(19) United States
(12) Patent Application Publication
(10) Pub. No.: US 2003/0069781 A1
(43) Pub. Date: Apr. 10, 2003

(54) Benchingmarking supplier products

(76) Inventors: Noel K. Hancock, San Jose, CA (US); Andre M. E. Nel, Fremont, CA (US); Jean-Christophe Pautrat, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 09/973,430

(22) Filed: Oct. 9, 2001

(51) Int. Cl. G06F 17/60

(52) U.S. Cl. 705/10

(57) ABSTRACT

Systems and methods of benchmarking product samples that are provided to a purchasing entity by multiple independent suppliers are described. This benchmarking scheme avoids the need for the purchasing entity to use its own testing equipment to perform evaluation testing of the product samples. At the same time, suppliers may obtain information regarding the performance of their products relative to the performance of products from competing suppliers, oftentimes well in advance of the time at which the products are released. In one aspect, multiple sets of performance parameter values corresponding to results of testing each of the product samples at test facilities of each of the suppliers are collected. An evaluation report is generated based upon the multiple sets of performance parameter values.

### TECHNICAL FIELD

This invention relates to systems and methods of benchmarking supplier products.

### BACKGROUND

Many manufacturers, such as original equipment manufacturers (OEMs), produce complex equipment (e.g., computer systems) from component parts that are purchased from other manufacturers (or suppliers). It is highly desirable for such manufacturers to evaluate the performance and other characteristics of component parts from a number of different competing suppliers before selecting a particular component part to incorporate into their equipment. For example, suppliers may be inclined to shade performance data to make their products look more favorable. Thus, performance evaluation testing across multiple parts may allow a manufacturer to obtain performance values that may be more reliable than performance values provided by suppliers themselves. The manufacturers may more confidently use the results of such an evaluation to select a component part that meets required performance specifications.

Various benchmarking techniques may be used to evaluate a set of related component parts, which may be devices, systems or software. In the course of these benchmarking techniques, key attributes of interest may be measured, and the results of these measurements may be used as the basis for a comparative analysis of the related component parts.

Benchmark tests for hardware component parts use software programs and test boards to assess the capabilities of the component parts. One frequently used test attribute of a microprocessor, for example, is the speed at which a microprocessor executes instructions or handles floating-point numbers. One benchmarking technique for analyzing the floating-point performance of a computer system is known as the Whetstone Benchmark. Benchmark performance tests also are frequently used to evaluate the performance of computer disk storage products such as, for example, disk drives. Generally, such benchmark tests are used to test response time performance (i.e., how quickly input/output (I/O) completion occurs when reading or writing), and throughput performance (i.e., the number of I/O operations that a drive can process per second). Benchmark tests for software component parts typically measure the efficiency, accuracy, or speed of a program in performing a particular task, such as recalculating data in a spreadsheet. The same data preferably is used with each program tested so that the resulting scores may be compared.

Benchmarking tests of component parts typically are performed by the manufacturer that is interested in purchasing the component parts. In general, the manufacturer receives one or more component product samples from multiple potential suppliers. The manufacturer may request samples from the potential suppliers, or the potential suppliers may send unsolicited samples (e.g., pre-production samples) to the manufacturer for evaluation. The manufacturer then configures its own test system to perform one or more benchmarking tests on the received component parts. The configuration process typically involves designing, building and debugging complex test boards and test programs, which is an expensive, laborious and time-consuming process. In addition, to keep up with improvements in the speed and capacity of component parts, manufacturers frequently must upgrade their test systems or purchase new test systems that have a cost and complexity that increases with each new generation of components to be tested.

### SUMMARY

The invention features systems and methods of benchmarking product samples that are provided to a purchasing entity by multiple independent suppliers that avoids the need for the purchasing entity to use its own testing equipment to perform evaluation testing of the product samples. In addition, the invention allows the purchasing entity to avoid the delay and expense that often is associated with third-party testing entities. At the same time, the invention enables suppliers to obtain information regarding the performance of their products relative to the performance of products from competing suppliers, oftentimes well in advance of the time at which the products are released. Suppliers may use this information to improve the design and other features of their products and thereby increase the demand for their products, while still getting the products to market within narrow time-to-market windows and meeting product price/performance specifications. In addition, the invention provides suppliers with some information about how their testing facilities compare with the facilities of competing suppliers. Suppliers may use this information to improve aspects of their testing and manufacturing facilities to further increase the demand for their product.

Thus, the invention may be implemented to provide a self-checking industry-wide benchmarking resource that compiles and disseminates performance information that may be used to improve the quality of the component products, while maintaining the confidentiality and security of the suppliers' proprietary information. At the same time, the invention provides incentives for suppliers to participate in the benchmarking process.

In one aspect, the invention features a method of benchmarking product samples provided to a purchasing entity by multiple independent suppliers. In accordance with this inventive method, multiple sets of performance parameter values corresponding to results of testing each of the product samples at test facilities of each of the suppliers are collected. An evaluation report is generated based upon the multiple sets of performance parameter values.

Embodiments of the invention may include one or more of the following features.

The step of collecting multiple sets of performance parameter values preferably comprises testing the product samples at test facilities of each of the suppliers. The testing of product samples may be controlled by the purchasing entity. The purchasing entity preferably prevents unauthorized access to the product samples during testing. For example, the purchasing entity may maintain custody of the product samples during testing.

Identification information may be removed from the product samples before testing. The step of removing identification information may comprise removing from each product any information from which the product supplier is identifiable.

The product samples preferably are tested at test facilities of each of the suppliers under substantially similar test conditions.

The multiple sets of performance parameters preferably are analyzed. A single consistent set of performance parameter values preferably is compiled from the multiple sets of performance parameter values.

The evaluation report may be transmitted to one or more of the suppliers. In some embodiments, a fee may be collected from a given supplier before transmitting the evaluation report to the given supplier. The evaluation report may be customized so that a supplier receiving the evaluation report is able to benchmark performance of its product sample against other product samples without identifying other suppliers. For example, the evaluation report may be customized by encoding identification information of all suppliers other than the receiving supplier.

The step of generating the evaluation report may comprise compiling a data structure relating parameter values and supplier test facilities for each product sample. The step of generating the evaluation report also may comprise producing a graph displaying one or more performance parameter values for each of the product samples.

In another aspect, the invention features a computer program for benchmarking product samples provided to a purchasing entity by multiple independent suppliers. The computer program resides on a computer-readable medium and comprises computer-readable instructions for causing a computer to: collect multiple sets of performance parameter values corresponding to results of testing each of the product samples at test facilities of each of the suppliers; and generate an evaluation report based upon the multiple sets of performance parameter values.

Other features and advantages of the invention will become apparent from the following description, including the drawings and the claims.

### DESCRIPTION OF DRAWINGS

FIG. 1 is a diagrammatic view of a method of benchmarking product samples that are provided to a purchasing entity by multiple independent suppliers.

FIG. 2 is a flow diagram of the benchmarking method of FIG. 1.

FIG. 3A is a diagrammatic view of an exemplary data structure relating performance parameter values and supplier test facilities for each product sample to be evaluated in accordance with the benchmarking method of FIG. 1.

FIG. 3B is a diagrammatic view of an exemplary bar graph depicting the information compiled in the data structure of FIG. 3A for a particular performance parameter.

FIG. 4 is a flow diagram of a method of distributing to one or more suppliers evaluation reports that are generated in accordance with the benchmarking method of FIG. 1.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

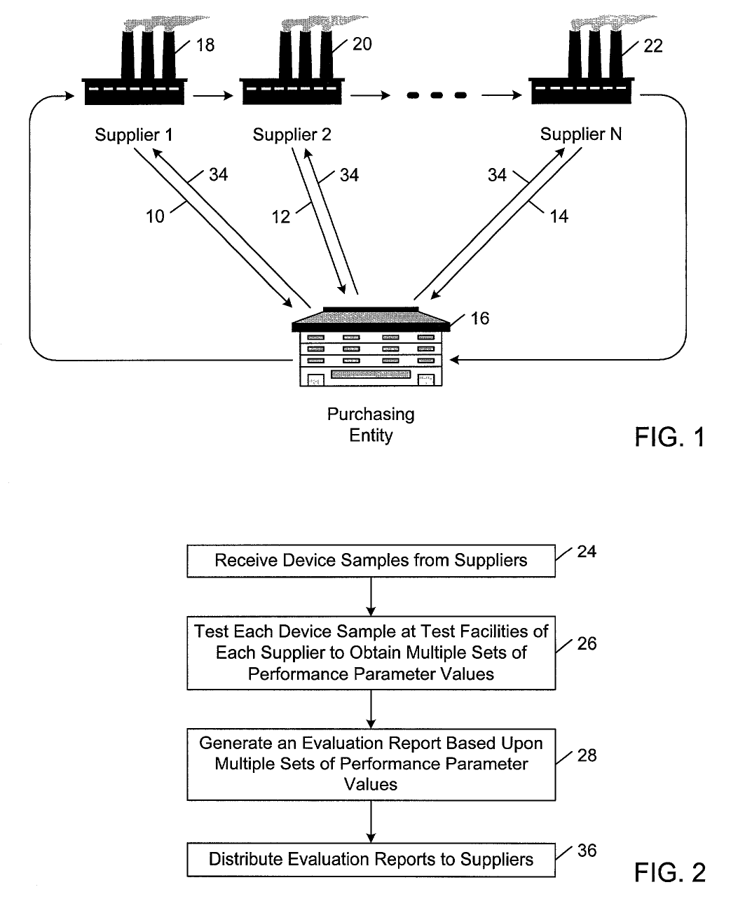

Referring to FIGS. 1 and 2, in one embodiment, product samples 10, 12, 14 are provided to a purchasing entity 16 by one or more suppliers 18, 20, 22 (Supplier 1, Supplier 2, . . . , Supplier N) (step 24). Product samples may be any product that the purchasing entity has an interest in evaluating, including any hardware product, software product and any firmware product. Purchasing entity 16 may be a manufacturer, such as an original equipment manufacturer, that produces complex equipment (e.g., computer systems) from component parts. Alternatively, purchasing entity 16 may be an independent third-party product evaluator that benchmarks products across an industry, or a segment of an industry, and distributes the information to suppliers 18-22 or to potential buyers (e.g., manufacturers or other customers) that are interested in purchasing products from suppliers 18-22, or both. Suppliers 18-22 may be conventional product-supplying entities, including product manufacturers and distributors.

After receiving the product samples 10-14 from suppliers 18-22 (step 24), purchasing entity 16 tests each product sample at test facilities of each supplier 18-22 to obtain multiple sets of performance parameter values (step 26). In one embodiment, a representative of purchasing entity 16 takes the set of product samples 10-14 from one supplier 18-22 to another and test each product sample using the test facilities of supplier 18-22. The purchasing entity representative controls the testing of the product samples and prevents unauthorized access to the product samples during the testing process. For example, the purchasing entity representative may maintain custody of the product samples 10-14 during testing. In another embodiment, a neutral third-party test administrator may control access to product samples 10-14 during testing.

In some embodiments, prior to testing the product samples 10-14, the purchasing entity representative, or the suppliers themselves, may remove all identification information from the product samples. Preferably, any information from which a product supplier may be identified is removed, including any labels naming the supplier and any branding information for the products corresponding to the product samples. The way in which identification information is removed depends upon the nature of the product samples being tested. For example, in the case of memory products, such as SDRAMs, the external surface of the physical casing or packaging of the products may be polished (e.g., by sandblasting or other conventional technique) until the identification is removed. Alternatively, a layer or coating of an opaque material may be applied to the external surfaces of the product sample packaging. In the case of software samples, identification information may be removed from the software code being supplied and from any computer-readable medium on which the software code resides. In this way, suppliers will not be able to identify their products during testing and, therefore, will not be able to shade the test results in favor of their products. In addition, suppliers will not be able to identify the product samples of other suppliers and, therefore, will have less incentive to breach the control restrictions imposed by purchasing entity 16 for the purpose of learning from the product samples proprietary information of other suppliers (e.g., by analyzing and otherwise inspecting the product samples of other suppliers).

The actual testing that is performed at the test facilities of suppliers 18-22 will depend upon the nature of the products being tested. In general, industry-standard tests preferably are performed on the product samples under conditions that are substantially the same from one test facility to another. Multiple performance parameter values may be obtained from each testing facility for each product sample. In some instances, a performance parameter is determined for each product sample from a calculation involving multiple parameters. For example, with respect to CPU (central processing unit) product samples, the Gibson Mix test or the Dhrystone Benchmark test may be used to arrive at a single performance parameter value for each product sample. Both of these performance measures are concerned with the speed of a CPU. The Dhrystone Benchmark measures the speed of executing a given number of program statements on a CPU. The Gibson Mix refers to the mix of instructions used by a computer while executing scientific programs. The Gibson Mix is used as a workload model for a CPU. The Gibson Mix provides a weighted sum as the mix of a set of instructions. Storage systems, on the other hand, such as disk drives and random access memories, are functionally different from processors, and a different set of performance parameters would be used to benchmark their performance.

The product samples preferably are sufficiently related to each other so that issues relating to the difficulty of scientifically comparing product samples with vastly different architectures or programming environments may be avoided. In addition, fair benchmark tests are preferred over benchmark tests that are designed for one architecture or programming model and that put different architectures at a disadvantage, even when nominal performance otherwise is similar. The fair benchmarks employed preferably objectively quantify product performance across various combinations of hardware and software, which may exhibit widely variable performance under different conditions.

After the product samples 10-14 have been tested at the test facilities of each of the suppliers (step 26), an evaluation report is generated based upon the multiple sets of performance parameter values that are obtained for each product sample (step 28).

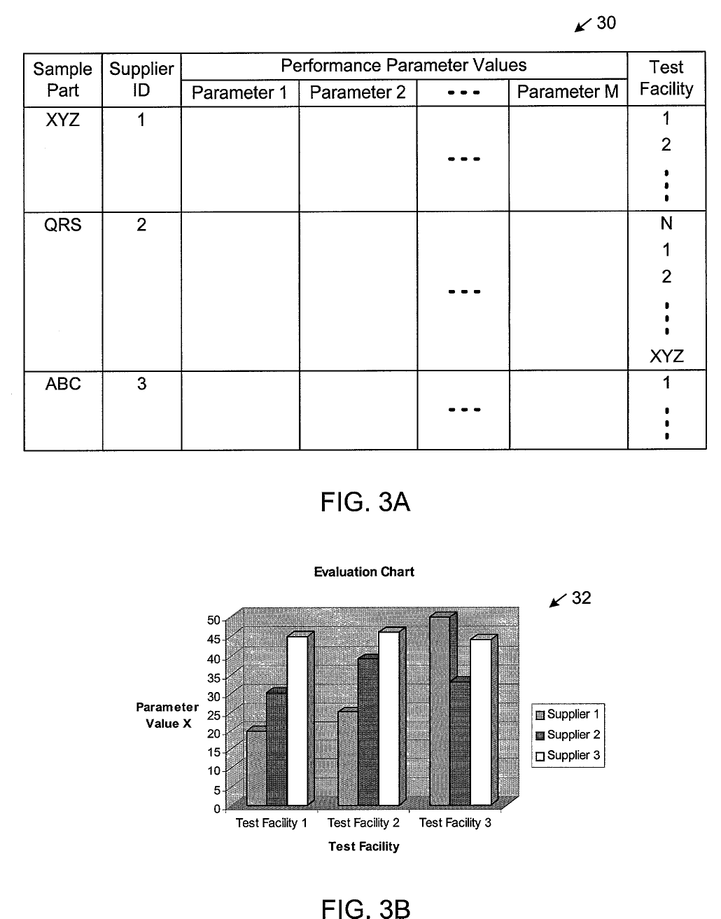

As shown in FIGS. 3A and 3B, the evaluation report may include a data structure 30 (e.g., a table) that relates performance parameter values and supplier test facility for each product sample under evaluation, and a graph 32 that displays some or all of the information contained in data structure 30. The information contained in data structure 30 and displayed in graph 32 may be used as a basis for a comparative analysis of the product samples under evaluation. In addition, this information may be used to identify and discard outliers, such as abnormally high or abnormally low performance parameter values. Outliers may be the result of improper shading of values higher or lower by a particular test facility that was able to identify its own product or identify one or more of the products of the other is suppliers. Outliers also may result when different test procedures are used at each of the test facilities. For example, the test procedure used at one supplier facility may have been designed to test a particular product architecture or software operating environment and, as a result, inadvertently generates performance parameter values that favor that architecture or operating environment over other designs.

The evaluation report also may include the results of one or more statistical analyses performed on the performance parameter data.

Referring back to FIG. 2, after an evaluation report has been generated based upon the performance parameter values collected from each test facility (step 28), one or more evaluation reports 34 may be distributed to one or more of suppliers 18-25 22 (step 36).

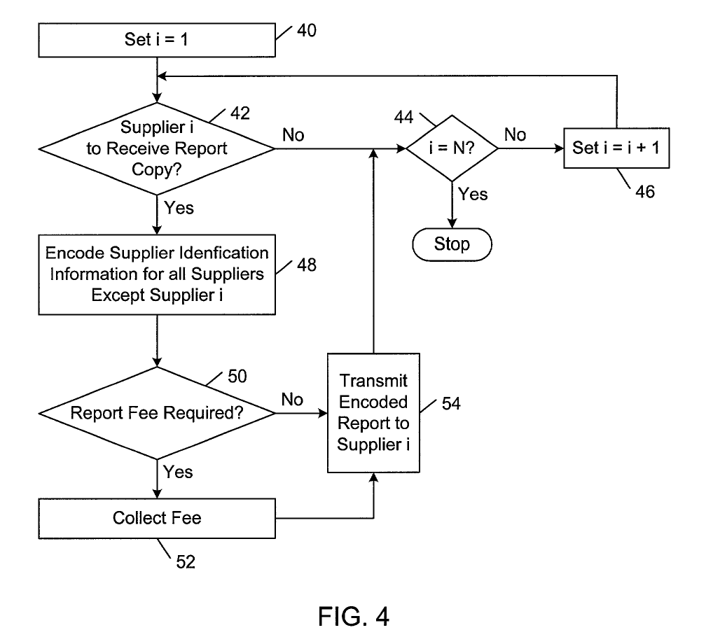

Referring to FIG. 4, in one embodiment, evaluation reports 34 may be distributed to one or more of suppliers 18-22, as follows. For each supplier i (i=1 through N), purchasing entity 16 determines whether supplier i is to receive a copy of the evaluation report (steps 40, 42, 44, 46). Suppliers 18-22 may have negotiated to receive a copy of the evaluation report under a variety of different conditions. For example, suppliers 18-22 may have required purchasing entity 16 to supply a copy of the report in exchange for allowing purchasing entity 16 (or a neutral third-party test administrator) to perform evaluation testing at their facilities. Alternatively, suppliers 18-22 may have signed up to receive a copy of the evaluation report as part of a subscription service. If supplier i is to receive a copy of the evaluation report (step 42), purchasing entity 16 encodes any supplier identification information contained in the report, except information relating to supplier i (step 48). In this regard, the identification information for supplier i may explicitly identify supplier i, or all of the supplier identifiers may be encoded and purchasing entity 16 may simply inform supplier i of the code corresponding to the product or products of supplier i. If a report fee is required (step 50), the purchasing entity collects the report fee (step 52) before transmitting the encoded report to supplier i (step 54). The evaluation report may be transmitted electronically (e.g., by e-mail or through a secure web site) or by a conventional physical mail service.

The systems and methods described herein are not limited to any particular hardware or software configuration, but rather they may be implemented in any computing or processing environment, including in digital electronic circuitry or in computer hardware, firmware or software. The evaluation report generation process and the report distribution process each may be implemented, in part, in a computer program product tangibly embodied in a machine-readable storage product for execution by a computer processor. In some embodiments, these processes preferably are implemented in a high level procedural or object oriented programming language; however, the algorithms may be implemented in assembly or machine language, if desired. In any case, the programming language may be a compiled or interpreted language. These processes also may be performed by a computer processor executing instructions organized, e.g., into program modules to carry out these methods by operating on input data and generating output. Suitable processors include, for example, both general and special purpose microprocessors. Generally, a processor receives instructions and data from a read-only memory and/or a random access memory. Storage products suitable for tangibly embodying computer program instructions include all forms of non-volatile memory, including, for example, semiconductor memory products, such as EPROM, EEPROM, and flash memory products; magnetic disks such as internal hard disks and removable disks; magneto-optical disks; and CD-ROM. Any of the foregoing technologies may be supplemented by or incorporated in specially-designed ASICs (application-specific integrated circuits).

Other embodiments are within the scope of the claims.

What is claimed is:

1. A method of benchmarking product samples provided to a purchasing entity by multiple independent suppliers, comprising:
collecting multiple sets of performance parameter values corresponding to results of testing each of the product samples at test facilities of each of the suppliers; and
generating an evaluation report based upon the multiple sets of performance parameter values.

2. The method of claim 1, wherein collecting multiple sets of performance parameter values comprises testing the product samples at test facilities of each of the suppliers.

3. The method of claim 2, wherein testing of product samples is controlled by the purchasing entity.

4. The method of claim 3, wherein the purchasing entity prevents unauthorized access to the product samples during testing.

5. The method of claim 3, wherein the purchasing entity maintains custody of the product samples during testing.

6. The method of claim 2, further comprising removing identification information from the product samples before testing.

7. The method of claim 6, wherein removing identification information comprises removing from each product any information from which the product supplier is identifiable.

8. The method of claim 2, wherein the product samples are tested at test facilities of each of the suppliers under substantially similar test conditions.

9. The method of claim 1, further comprising analyzing the multiple sets of performance parameters.

10. The method of claim 8, further comprising compiling a single consistent set of performance parameter values from the multiple sets of performance parameter values.

11. The method of claim 1, further comprising transmitting the evaluation report to one or more of the suppliers.

12. The method of claim 11, further comprising collecting a fee from a given supplier before transmitting the evaluation report to the given supplier.

13. The method of claim 11, further comprising customizing the evaluation report so that a supplier receiving the evaluation report is able to benchmark performance of its product sample against other product samples without identifying other suppliers.

14. The method of claim 13, wherein the evaluation report is customized by encoding identification information of all suppliers other than the receiving supplier.

15. The method of claim 1, wherein generating the evaluation report comprises compiling a data structure relating parameter values and supplier test facilities for each product sample.

16. The method of claim 15, wherein generating the evaluation report comprises producing a graph displaying one or more performance parameter values for each of the product samples.

17. A computer program for benchmarking product samples provided to a purchasing entity by multiple independent suppliers, the computer program residing on a computer-readable medium and comprising computer-readable instructions for causing a computer to:
collect multiple sets of performance parameter values corresponding to results of testing each of the product samples at test facilities of each of the suppliers; and
generate an evaluation report based upon the multiple sets of performance parameter values.

18. The computer program of claim 17, further comprising computer-readable instructions for analyzing the multiple sets of performance parameters.

19. The computer program of claim 18, further comprising computer-readable instructions for compiling a single consistent set of performance parameter values from the multiple sets of performance parameter values.

20. The computer program of claim 17, further comprising computer-readable instructions for customizing the evaluation report so that a supplier receiving the evaluation report is able to benchmark performance of its product sample against other product samples without identifying other suppliers.
